(19) United States
(12) Patent Application Publication
(10) Pub. No.: US 2025/0329785 A1
(43) Pub. Date: Oct. 23, 2025

(54) ELECTROLYTE FOR RECHARGEABLE LITHIUM BATTERY, ELECTROLYTE ADDITIVE AND RECHARGEABLE LITHIUM BATTERY INCLUDING THE SAME

(71) Applicant: SAMSUNG SDI CO., LTD., Yongin-si (KR)

(72) Inventors: Euisoo JEONG, Yongin-si (KR); SANGHOON KIM, Yongin-si (KR); Sujeong KOH, Yongin-si (KR); Erang CHO, Yongin-si (KR); Bomee KWON, Yongin-si (KR); SUNDAE KIM, Yongin-si (KR); Yeji YANG, Yongin-si (KR); JINAH SEO, Yongin-si (KR); JIN-HYEOK LIM, Yongin-si (KR)

(21) Appl. No.: 18/990,785

(22) Filed: Dec. 20, 2024

(30) Foreign Application Priority Data
Apr. 17, 2024 (KR) 10-2024-0051634

(51) Int. Cl. H01M 10/0567; H01M 4/02; H01M 4/38; H01M 4/525; H01M 4/583; H01M 10/0525; H01M 10/0568; H01M 10/0569

(52) U.S. Cl. CPC H01M 10/0567; H01M 4/386; H01M 4/525; H01M 4/583; H01M 10/0525; H01M 10/0568; H01M 10/0569; H01M 2004/027; H01M 2004/028; H01M 2300/004

(57) ABSTRACT

An electrolyte, an electrolyte additive, and a rechargeable lithium battery are disclosed. The electrolyte includes a non-aqueous organic solvent, a lithium salt, and an additive represented by Chemical Formula 1. A detailed description of the Chemical Formula 1 of the additive is disclosed.

### CROSS-REFERENCE TO RELATED APPLICATION

The present application claims priority to and the benefit of Korean Patent Application No. 10-2024-0051634, filed on Apr. 17, 2024, in the Korean Intellectual Property Office, the entire disclosure of which is incorporated herein by reference.

### BACKGROUND

### 1. Field

One or more embodiments of the present disclosure relate to an electrolyte for a rechargeable lithium battery, an electrolyte additive, and a rechargeable lithium battery including the electrolyte.

### 2. Description of the Related Art

With the widespread adoption of battery-powered electronic devices, such as mobile phones and laptops, and electric vehicles, it is desirable to develop rechargeable batteries that offer both high energy density and high capacity. Extensive research efforts have been dedicated to enhancing the performance of rechargeable lithium batteries.

A rechargeable lithium battery contains a positive electrode, a negative electrode, and an electrolyte. The positive electrode and the negative electrode include an active material, in which intercalation and deintercalation of lithium ions may occur, and generate electrical energy caused by oxidation and reduction reactions.

### SUMMARY

One or more aspects of embodiments of the present disclosure are directed toward an electrolyte for a rechargeable lithium battery having improved high-temperature stability.

One or more aspects of embodiments of the present disclosure are directed toward a rechargeable lithium battery including an electrolyte as described in one or more embodiments of the present disclosure.

According to one or more embodiments of the present disclosure, an electrolyte for a rechargeable lithium battery may include: a non-aqueous organic solvent; a lithium salt; and an additive represented by Chemical Formula 1.

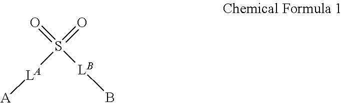

In Chemical Formula 1, L^{A} and L^{B} may each independently be a substituted or unsubstituted C1 to C5 alkylene group, a substituted or unsubstituted C2 to C5 alkenylene group, a substituted or unsubstituted C2 to C5 alkynylene group, or a substituted or unsubstituted C6 to C20 arylene group.

In Chemical Formula 1, A and B may each independently be a substituted or unsubstituted C1 to C20 alkyl group, a substituted or unsubstituted C6 to C20 aryl group, or a substituted or unsubstituted C2 to C20 heteroaryl group.

In Chemical Formula 1, at least one selected from A and B may be an azide group. For example, the azide group may be bonded directly to “S” of Chemical Formula 1 and/or may be a substituent of the substituted C1 to C20 alkyl group, the substituted C6 to C20 aryl group, and/or the substituted C2 to C20 heteroaryl group, such that A and B may each independently be an azide group, a C1 to C20 alkyl group that is unsubstituted or substituted with an azide group, a C6 to C20 aryl group that is unsubstituted or substituted with an azide group, or a substituted or unsubstituted C2 to C20 heteroaryl group that is unsubstituted or substituted with an azide group.

According to one or more embodiments of the present disclosure, an additive may be represented by Chemical Formula 1-2.

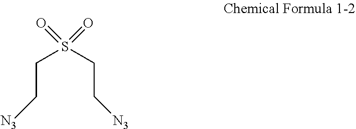 [SMILES: [N-]=[N+]=NCCS(=O)(=O)CCN=[N+]=[N-]]

One or more aspects of embodiments of the present disclosure are directed toward a rechargeable lithium battery, wherein the rechargeable lithium battery includes: a positive electrode, wherein the positive electrode includes a positive electrode active material; a negative electrode, wherein the negative electrode includes a negative electrode active material; and the electrolyte for the rechargeable lithium battery as described in one or more embodiments of the present disclosure.

Additional aspects of embodiments will be set forth in part in the description which follows and, in part, will be apparent from the description, or may be learned by practice of the presented embodiments of the disclosure.

### BRIEF DESCRIPTION OF THE DRAWINGS

The above and other aspects and advantages of certain embodiments of the present disclosure will be more apparent from the following description taken in conjunction with the accompanying drawings.

FIG. 1 is a simplified conceptual diagram showing a rechargeable lithium battery according to one or more embodiments of the present disclosure.

FIGS. 2-5 each is a simplified diagram showing a rechargeable lithium battery according to one or more embodiments of the present disclosure.

FIG. 6 is a graph showing cyclic voltammetry results for solutions including an additive prepared according to Synthesis Example 1 and for solutions including no additive.

FIG. 7 is a graph showing cyclic voltammetry results under different conditions of FIG. 6 for solutions including an additive prepared according to Synthesis Example 1 and for solutions including no additive.

FIG. 8 is a ¹H nuclear magnetic resonance (NMR) spectrum of a compound according to Synthesis Example 1.

### DETAILED DESCRIPTION

In order to sufficiently understand configurations and aspects of embodiments of the present disclosure, one or more embodiments of the present disclosure will be described with reference to the accompanying drawings. It should be noted, however, that the present disclosure is not limited to the following example embodiments and may be implemented in one or more suitable forms. Rather, the example embodiments are provided only to illustrate the present disclosure and let those having ordinary skill in the art fully understand the scope of the present disclosure.

In the present disclosure, it will be understood that, if (e.g., when) an element is referred to as being on another element, the element may be directly on the other element or intervening elements may be present therebetween. In some embodiments, if (e.g., when) an element is referred to as being “directly on” another element, there are no intervening elements present. In the drawings, thicknesses of some components may be exaggerated to effectively explain the technical contents of the present disclosure. Like reference numerals refer to like elements throughout the present disclosure, and duplicative descriptions thereof may not be provided for conciseness.

Unless otherwise specially noted in the present disclosure, the singular forms, “a,” “an,” and “the,” are intended to include the plural forms as well unless the context clearly indicates otherwise. Further, the utilization of “may” when describing embodiments of the present disclosure refers to “one or more embodiments of the present disclosure.” In embodiments, unless otherwise specially noted, the phrase, “A or B,” “A and/or B,” or “A/B,” may indicate “A but not B,” “B but not A,” and “A and B.” The terms, “comprises/includes” and/or “comprising/including” used in this disclosure, do not exclude the presence or addition of one or more other components.

As used herein, the term, “combination thereof,” may refer to a mixture, a stack, a composite, a copolymer, an alloy, a blend, or a reaction product of the constituents.

In one or more embodiments of the present disclosure, unless otherwise separately defined, the term, “substituted,” may refer to that at least one hydrogen of a substituent or a compound is substituted by deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, C1 to C20 alkoxy group, a C1 to C10 fluoroalkyl group, a cyano group, and/or a (e.g., any suitable) combination thereof.

In some embodiments, the term, “substituted,” may refer to that at least one hydrogen of a substituent or a compound is substituted by deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the term, “substituted,” may refer to that at least one hydrogen of a substituent or a compound is substituted by deuterium, a halogen group, a C1 to C20 alkyl group, a C6 to C30 aryl group, a C1 to C10 fluoroalkyl group, or a cyano group. In some embodiments, the term, “substituted,” may refer to that at least one hydrogen of a substituent or a compound is substituted by deuterium, a halogen group, a C1 to C5 alkyl group, a C6 to C18 aryl group, a C1 to C5 fluoroalkyl group, or a cyano group. For example, the term, “substituted,” may refer to that at least one hydrogen of a substituent or a compound is substituted by deuterium, a cyano group, a halogen group, a methyl group, an ethyl group, a propyl group, a butyl group, a phenyl group, a biphenyl group, a terphenyl group, a trifluoromethyl group, or a naphthyl group.

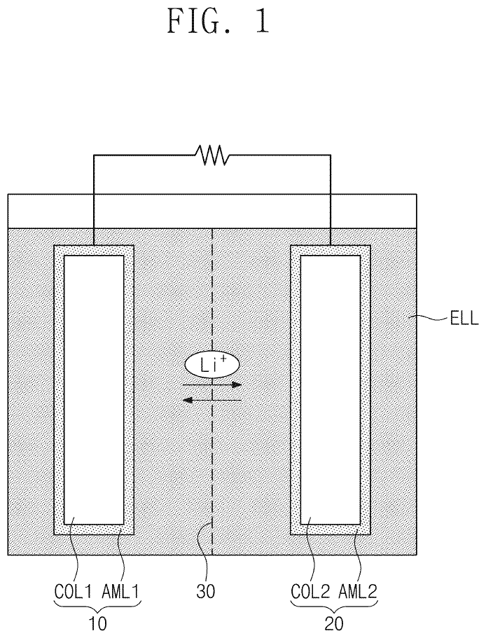

FIG. 1 illustrates a simplified conceptual diagram showing a rechargeable lithium battery according to one or more embodiments of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced and/or apart (e.g., spaced apart or separated) from each other across the separator 30. The separator 30 may be arranged between the positive electrode 10 and the negative electrode 20. The positive electrode 10, the negative electrode 20, and the separator 30 may be in contact with the electrolyte ELL. In some embodiments, the positive electrode 10, the negative electrode 20, and the separator 30 may be impregnated in (and/or with) the electrolyte ELL.

The electrolyte ELL may be a medium in which lithium ions are migrated and transferred between the positive electrode 10 and the negative electrode 20. In the electrolyte ELL, the lithium ions may move through the separator 30 toward one of the positive electrode 10 or the negative electrode 20.

### Positive Electrode 10

The positive electrode 10 for a rechargeable lithium battery may include a current collector COL1 and a positive electrode active material layer AML1 on the current collector COL1. The positive electrode active material layer AML1 may include a positive electrode active material (e.g., in a form of particles) and may further include a binder and/or a conductive material (e.g., an electrically conductive material).

For example, in some embodiments, the positive electrode 10 may further include an additive that may serve as a sacrificial positive electrode.

An amount of the positive electrode active material may be in a range of about 90 wt % to about 99.5 wt % relative to 100 wt % of a total weight of the positive electrode active material layer AML1. An amount of each of the binder and the conductive material may be in a range of about 0.5 wt % to about 5 wt % relative to 100 wt % of the total weight of the positive electrode active material layer AML1.

The binder may serve to improve attachment of positive electrode active material particles to each other and also to improve attachment of the positive electrode active material to the current collector COL1. The binder may include, for example, one or more selected from among polyvinyl alcohol, carboxymethyl cellulose, hydroxypropyl cellulose, diacetyl cellulose, polyvinylchloride, carboxylated polyvinylchloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and/or nylon, but embodiments of the present disclosure are not limited thereto.

The conductive material (e.g., an electrically conductive material or electron conductor) may be used to provide an electrode with conductivity (e.g., electrical conductivity), and any suitable conductive material without causing chemical change of (e.g., that does not cause an undesirable chemical change) a battery may be used as the conductive material to constitute the battery. The conductive material may include, for example, a carbon-based material, such as natural graphite, artificial graphite, carbon black, acetylene black, Ketjen black, carbon fiber, carbon nanofiber, and/or carbon nanotube; a metal powder and/or a metal fiber containing one or more selected from among copper, nickel, aluminum, silver, and/or a (e.g., any suitable) combination thereof; a conductive polymer (e.g., an electrically conductive polymer), such as a polyphenylene derivative; and/or a (e.g., any suitable) mixture thereof.

In some embodiments, aluminum (Al) may be used as the current collector COL1, but embodiments of the present disclosure are not limited thereto.

### Positive Electrode Active Material

The positive electrode active material in the positive electrode active material layer AML1 may include a compound (e.g., a lithiated intercalation compound) that may reversibly intercalate and deintercalate lithium. For example, the positive electrode active material may include at least one kind of composite oxide including lithium and a metal that may be selected from among cobalt, manganese, nickel, and/or a (e.g., any suitable) combination thereof.

The composite oxide may include lithium transition metal composite oxides, for example, lithium-nickel-based oxides, lithium-cobalt-based oxides, lithium-manganese-based oxides, lithium-iron-phosphate-based compounds, cobalt-free nickel-manganese-based oxides, and/or a (e.g., any suitable) combination thereof.

For example, the positive electrode active material may include a compound represented by one selected from among the chemical formulae: LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}Co_{b}X_{c}O_{2-α}D_{α} (where 0.90≤a≤1.8, 0≤b≤0.5, 0≤c≤0.5, and 0<α<2); LiₐNi_{1-b-c}Mn_{b}X_{c}O_{2-α}D_{α} (where 0.90≤a≤1.8, 0≤b≤0.5, 0≤c≤0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8); and/or a (e.g., any suitable) combination thereof.

In the foregoing chemical formulae, A may be nickel (Ni), cobalt (Co), manganese (Mn), and/or a (e.g., any suitable) combination thereof, X may be Al, Ni, Co, Mn, chromium (Cr), iron (Fe), magnesium (Mg), strontium (Sr), vanadium (V), a rare-earth element, and/or a (e.g., any suitable) combination thereof, D may be oxygen (O), fluorine (F), sulfur (S), phosphorus (P), and/or a (e.g., any suitable) combination thereof, G may be Al, Cr, Mn, Fe, Mg, lanthanum (La), cerium (Ce), Sr, V, and/or a (e.g., any suitable) combination thereof, and L¹ may be Mn, Al, or a combination thereof.

For example, the positive electrode active material may be a high nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of a total metal excluding lithium in the lithium transition metal composite oxide. The high-nickel-based positive electrode active material may achieve high capacity and thus may be applied to a high-capacity and high-energy-density rechargeable lithium battery.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active material (e.g., in a form of particles) and may further include a binder and/or a conductive material (e.g., an electrically conductive material).

For example, the negative electrode active material layer AML2 may include a negative electrode active material of about 90 wt % to about 99 wt %, a binder of about 0.5 wt % to about 5 wt %, and a conductive material of about 0 wt % to about 5 wt %, based on 100 wt % of a total weight of the negative electrode active material layer AML2.

The binder may serve to improve attachment of negative electrode active material particles to each other and also to improve attachment of the negative electrode active material to the current collector COL2. The binder may include a non-aqueous (e.g., water-insoluble) binder, an aqueous (e.g., water-soluble) binder, a dry binder, and/or a (e.g., any suitable) combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamide imide, polyimide, and/or a (e.g., any suitable) combination thereof.

The aqueous binder may include a styrene-butadiene rubber, a (meth)acrylated styrene-butadiene rubber, a (meth)acrylonitrile-butadiene rubber, a (meth)acrylic rubber, a butyl rubber, a fluoro elastomer, polyethylene oxide, polyvinyl pyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenolic resin, an epoxy resin, polyvinyl alcohol, and/or a (e.g., any suitable) combination thereof.

If (e.g., when) an aqueous binder is used as the binder of the negative electrode, a cellulose-based compound capable of providing or increasing viscosity may further be included. The cellulose-based compound may include one or more selected from among carboxymethyl cellulose, hydroxypropyl methylcellulose, methyl cellulose, and/or alkali metal salts thereof. The alkali metal may include Na, K, and/or Li.

The dry binder may include a fibrillizable polymer material, for example, polytetrafluoroethylene, polyvinylidene fluoride, a polyvinylidene fluoride-hexafluoropropylene copolymer, polyethylene oxide, and/or a (e.g., any suitable) combination thereof.

The conductive material (e.g., electrically conductive material or electron conductor) may be used to provide an electrode with conductivity (e.g., electrical conductivity), and any suitable conductive material without causing chemical change of (e.g., that does not cause an undesirable chemical change) a battery may be used as the conductive material to constitute the battery. For example, the conductive material may include a carbon-based material, such as natural graphite, artificial graphite, carbon black, acetylene black, Ketjen black, carbon fiber, carbon nanofiber, and/or carbon nanotube; a metal powder and/or a metal fiber including one or more selected from among copper, nickel, aluminum, and/or silver; a conductive polymer (e.g., an electrically conductive polymer), such as a polyphenylene derivative; and/or a (e.g., any suitable) mixture thereof.

The current collector COL2 may include a copper foil, a nickel foil, a stainless-steel foil, a titanium foil, a nickel foam, a copper foam, a polymer substrate coated with a conductive metal, and/or a (e.g., any suitable) combination thereof.

### Negative Electrode Active Material

The negative electrode active material in the negative electrode active material layer AML2 may include a material that may reversibly intercalate and deintercalate lithium ions, lithium metal, a lithium metal alloy, a material that may dope and de-dope lithium, and/or a transition metal oxide.

The material that may reversibly intercalate and deintercalate lithium ions may include a carbon-based negative electrode active material, for example, crystalline carbon, amorphous carbon, and/or a (e.g., any suitable) combination thereof. For example, the crystalline carbon may include graphite, such as non-shaped (e.g., irregularly shaped), sheet-shaped, flake-shaped, sphere-shaped, and/or fiber-shaped natural graphite and/or artificial graphite, and the amorphous carbon may include soft carbon, hard carbon, mesophase pitch carbon, and/or calcined coke.

The lithium metal alloy may include an alloy of lithium and a metal that is selected from among sodium (Na), potassium (K), rubidium (Rb), cesium (Cs), francium (Fr), beryllium (Be), magnesium (Mg), calcium (Ca), strontium (Sr), silicon (Si), antimony (Sb), lead (Pb), indium (In), zinc (Zn), barium (Ba), radium (Ra), germanium (Ge), aluminum (Al), tin (Sn), and/or a (e.g., any suitable) combination thereof.

The material that may dope and de-dope lithium may include a Si-based negative electrode active material and/or a Sn-based negative electrode active material. The Si-based negative electrode active material may include silicon, a silicon-carbon composite, SiOₓ (where 0<x≤2), an Si-Q alloy (where Q is an alkali metal, an alkaline earth metal, a Group 13 element, Group a 14 element (except for Si), a Group 15 element, a Group 16 element, a transition metal, a rare-earth element, or a (e.g., any suitable) combination thereof), and/or a (e.g., any suitable) combination thereof. The Sn-based negative electrode active material may include Sn, SnOₖ (where 0<k≤2) (e.g., SnO₂), a Sn-based alloy, and/or a (e.g., any suitable) combination thereof.

The silicon-carbon composite may be a composite of silicon and amorphous carbon (e.g., in a form of particles). In some embodiments, the silicon-carbon composite may have a structure in which the amorphous carbon is coated on a surface of each of silicon particle. For example, the silicon-carbon composite may include a secondary particle (core) in which primary silicon particles are assembled and an amorphous carbon coating layer (shell) on a surface of the secondary particle. The amorphous carbon may also be between the primary silicon particles, and for example, the primary silicon particles may be coated with the amorphous carbon. The secondary particles may be present dispersed in an amorphous carbon matrix.

The silicon-carbon composite may further include crystalline carbon. For example, the silicon-carbon composite may include a core including crystalline carbon and silicon particles and may also include an amorphous carbon coating layer on a surface of the core.

The Si-based negative electrode active material and/or the Sn-based negative electrode active material may be used in combination with a carbon-based negative electrode active material.

### Separator 30

Based on a type or kind of the rechargeable lithium battery, the separator 30 may be present between the positive electrode 10 and the negative electrode 20. The separator 30 may include one or more selected from among polyethylene, polypropylene, polyvinylidene fluoride, and/or a (e.g., any suitable) combination thereof, or may have a multi-layered separator thereof, such as a polyethylene/polypropylene bi-layered separator, a polyethylene/polypropylene/polyethylene tri-layered separator, and/or a polypropylene/polyethylene/polypropylene tri-layered separator.

The separator 30 may include a porous substrate and a coating layer on a surface (e.g., one surface or two opposite surfaces) of the porous substrate, and the coating layer may include an organic material, an inorganic material, and/or a (e.g., any suitable) combination thereof.

The porous substrate may be a polymer layer including one selected from among polyolefin, such as polyethylene and polypropylene, polyester, such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, a cyclic olefin copolymer, polyphenylenesulphide, polyethylene naphthalate, a glass fiber, and polytetrafluoroethylene (e.g., Teflon™), or may be a copolymer or a mixture including two or more thereof.

The organic material may include a polyvinylidene fluoride-based copolymer and/or a (meth)acrylic copolymer.

The inorganic material may include an inorganic particle selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, and/or a (e.g., any suitable) combination thereof, but embodiments of the present disclosure are not limited thereto.

The organic material and the inorganic material may be present mixed in one coating layer or may be present as a stack of a coating layer including the organic material and a coating layer including an inorganic material.

### Electrolyte ELL

The electrolyte ELL (e.g., electrolyte solution) for the rechargeable lithium battery may include a non-aqueous organic solvent and a lithium salt.

The non-aqueous organic solvent may serve as a medium that transmits ions that participate in an electrochemical reaction of the battery.

The non-aqueous organic solvent may include a carbonate-based solvent, an ester-based solvent, an ether-based solvent, a ketone-based solvent, an alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methyl propyl carbonate (MPC), ethyl propyl carbonate (EPC), ethyl methyl carbonate (EMC), ethylene carbonate (EC), propylene carbonate (PC), butylene carbonate (BC), and/or a (e.g., any suitable) combination thereof.

The ester-based solvent may include methyl acetate, ethyl acetate, n-propyl acetate, dimethyl acetate, methyl propionate, ethyl propionate, decanolide, mevalonolactone, valerolactone, caprolactone, and/or a (e.g., any suitable) combination thereof.

The ether-based solvent may include dibutyl ether, tetraglyme, diglyme, dimethoxyethane, 2-methyltetrahydrofuran, 2,5-dimethyltetrahydrofuran, tetrahydrofuran, and/or a (e.g., any suitable) combination thereof. The ketone-based solvent may include cyclohexanone. The alcohol-based solvent may include ethyl alcohol, isopropyl alcohol, and/or a combination thereof. The aprotic solvent may include nitriles, such as R—CN (where R may be a hydrocarbon group having a C2 to C20 linear, branched, or cyclic structure and may include a double bond, an aromatic ring, or an ether group); amides, such as dimethylformamide; dioxolanes, such as 1,3-dioxolane and/or 1,4-dioxolane; sulfolanes; and/or a (e.g., any suitable) combination thereof.

The non-aqueous organic solvent may be used alone or in a mixture of two or more thereof.

In some embodiments, if (e.g., when) a carbonate-based solvent is used, a cyclic carbonate and a chain carbonate may be mixed and used, and the cyclic carbonate and the chain carbonate may be mixed in a volume ratio of about 1:1 to about 1:9.

The lithium salt may be a material that is dissolved in the non-aqueous organic solvent to serve as a supply source of lithium ions in a rechargeable lithium battery and plays a role in enabling a basic operation of the rechargeable lithium battery and in promoting the movement of lithium ions between the positive electrode and the negative electrode. The lithium salt may include, for example, at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers between 1 to 20), lithium trifluoromethane sulfonate, lithium tetrafluoroethanesulfonate, lithium difluorobis(oxalato)phosphate (LiDFBOP), lithium bis(oxalato)borate (LiBOB), and/or a (e.g., any suitable) combination thereof.

The following describes in more detail an electrolyte for a rechargeable lithium battery according to one or more embodiments of the present disclosure.

An electrolyte for a rechargeable lithium battery according to one or more embodiments of the present disclosure may include a non-aqueous organic solvent, a lithium salt, and an additive represented by Chemical Formula 1 below.

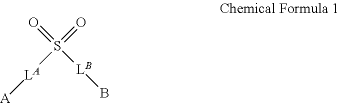

In Chemical Formula 1, L^{A} and L^{B} may each independently be a substituted or unsubstituted C1 to C5 alkylene group, a substituted or unsubstituted C2 to C5 alkenylene group, a substituted or unsubstituted C2 to C5 alkynylene group, or a substituted or unsubstituted C6 to C20 arylene group.

In Chemical Formula 1, A and B may each independently be a substituted or unsubstituted C1 to C20 alkyl group, a substituted or unsubstituted C6 to C20 aryl group, or a substituted or unsubstituted C2 to C20 heteroaryl group.

In Chemical Formula 1, at least one selected from A and B may be an azide group. For example, the azide group may be bonded directly to “S” of Chemical Formula 1 and/or may be a substituent of the substituted C1 to C20 alkyl group, the substituted C6 to C20 aryl group, and/or the substituted C2 to C20 heteroaryl group, such that A and B may each independently be an azide group, a C1 to C20 alkyl group that is unsubstituted or substituted with an azide group, a C6 to C20 aryl group that is unsubstituted or substituted with an azide group, or a substituted or unsubstituted C2 to C20 heteroaryl group that is unsubstituted or substituted with an azide group.

The electrolyte may be prepared by a mixing process in which a lithium salt is dissolved in a non-aqueous organic solvent, and an additive represented by Chemical Formula 1 as described in one or more embodiments of the present disclosure is added to mix the solution. The electrolyte mixing process may be any suitable generally used or generally available in the electrolyte fabrication field, and a person skilled in the art may be able to appropriately select and use the same upon reviewing this disclosure.

The non-aqueous organic solvent may include at least one selected from among ethylene carbonate (EC), propylene carbonate (PC), propyl propionate (PP), ethyl methyl carbonate (EMC), dimethyl carbonate (DMC), diethyl carbonate (DEC), dipropyl carbonate (DPC), methyl propyl carbonate (MPC), ethyl propyl carbonate (EPC), ethyl methyl carbonate (EMC), butylene carbonate (BC), and/or a (e.g., any suitable) combination thereof.

In some embodiments, the non-aqueous organic solvent may be a mixed solvent of ethylene carbonate (EC), ethyl methyl carbonate (EMC), and/or dimethyl carbonate (DMC).

For example, the ethylene carbonate (EC) solvent may be included in an amount of about 5 vol % to about 40 vol % or about 10 vol % to about 30 vol % relative to the total volume of the non-aqueous organic solvent. The ethyl methyl carbonate (EMC) solvent may be included in an amount of about 20 vol % to about 60 vol % or about 30 vol % to about 50 vol % relative to the total volume of the non-aqueous organic solvent. The dimethyl carbonate (DMC) solvent may be included in an amount of about 20 vol % to about 60 vol % or about 30 vol % to about 50 vol % relative to the total volume of the non-aqueous organic solvent.

In the electrolyte according to one or more embodiments of the present disclosure, the lithium salt may include LiPF₆.

The lithium salt may have a concentration of about 0.1 M to about 2.0 M. For example, the lithium salt may have a concentration of equal to or greater than about 0.5 M or equal to or greater than about 1.0 M. The lithium salt may have a concentration of equal to or less than about 2.0 M, equal to or less than about 1.7 M, or equal to or less than about 1.5 M. In one or more embodiments of the present disclosure, if (e.g., when) the lithium salt has a concentration of about 0.1 M to about 2.0 M, the electrolyte may suitably or appropriately maintain its conductivity (e.g., electrical conductivity) and viscosity.

### Additive

The additive according to one or more embodiments of the present disclosure may be represented by Chemical Formula 1 below.

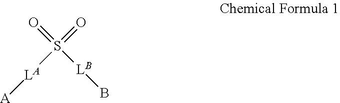

In Chemical Formula 1, L^{A} and L^{B} may each independently be a substituted or unsubstituted C1 to C5 alkylene group, a substituted or unsubstituted C2 to C5 alkenylene group, a substituted or unsubstituted C2 to C5 alkynylene group, or a substituted or unsubstituted C6 to C20 arylene group.

In Chemical Formula 1, A and B may each independently be a substituted or unsubstituted C1 to C20 alkyl group, a substituted or unsubstituted C6 to C20 aryl group, or a substituted or unsubstituted C2 to C20 heteroaryl group.

In Chemical Formula 1, at least one selected from A and B may be an azide group.

In Chemical Formula 1, at least one selected from L^{A} and L^{B} may be substituted or unsubstituted C1 to C5 alkylene or substituted or unsubstituted C2 to C4 alkylene. L^{A} and L^{B} may each independently be substituted or unsubstituted C1 to C5 alkylene or substituted or unsubstituted C2 to C4 alkylene.

In some embodiments, the additive may be represented by Chemical Formula 1-1 below.

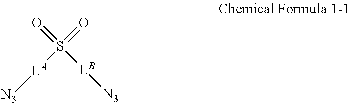

In Chemical Formula 1-1, L^{A} and L^{B} may each independently be substituted or unsubstituted C2 to C4 alkylene.

In some embodiments, the additive may include at least one selected from a compound represented by Chemical Formula 1-2 below and a compound represented by Chemical Formula 1-3 below.

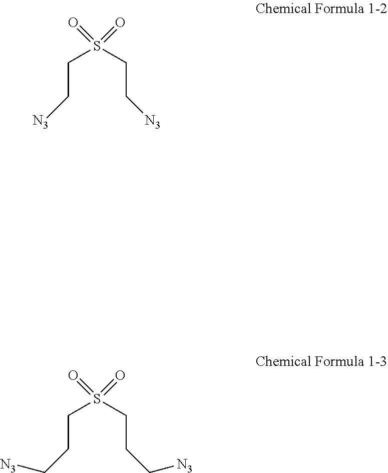 [SMILES: [N-]=[N+]=NCCS(=O)(=O)CCN=[N+]=[N-] ; [N-]=[N+]=NCCCS(=O)(=O)CCCN=[N+]=[N-]]

In some embodiments, the additive according to one or more embodiments of the present disclosure may include the compound represented by Chemical Formula 1-2 as described in one or more embodiments of the present disclosure.

The electrolyte additive according to one or more embodiments of the present disclosure may include a sulfone group and at least one azide group.

The sulfone group included in the additive may be oxidized during decomposition to form and reinforce a cathode electrolyte interface (CEI). For example, the sulfone group may be oxidized during decomposition to form a coordination bond with transition metals on or released from the surface of the positive electrode, thereby forming the CEI. The coordination bond may also be referred to as a coordinate covalent bond or dative bond. It may thus reduce gas generation caused by side reactions between the electrolyte and a cathode interface and to suppress or reduce gas generation and transition metal dissolution resulting from the decomposition of the positive electrode active material. The reduction in side reaction effect may become pronounced at high temperatures.

The azide group may form and reinforce a solid electrolyte interface (SEI). In some embodiments, a lone pair of electrons of the azide group may act on Lewis acid (e.g., PF₅⁻) which may be present in the electrolyte to stabilize the Lewis acid, thereby protecting the SEI. Moreover, the azide group may improve ion conductivity of the electrolyte to achieve a rapid charge.

In the additive of one or more embodiments of the present disclosure, the sulfone group and the azide group may be coupled through an alkylene group. If (e.g., when) the sulfone group and the azide group are directly coupled to each other, the additive may be decomposed such that a bond (e.g., S—N bond) between the sulfone group and the azide group may be broken, and such that no functional group may be present in the sulfone group. In some embodiments, if (e.g., when) the sulfone group and the azide group are coupled through an alkylene group, a functional group may remain in the sulfone group even if (e.g., when) the additive is decomposed to detach the azide group. The functional group remaining in the sulfone group may act subsequently as another functional additive to protect the SEI and the CEI.

In the electrolyte for a rechargeable lithium battery according to the present disclosure, the additive may be included to protect the SEI and the CEI and to reduce a side reaction between the electrolyte and an electrode and a side reaction within the electrolyte. Thus, the rechargeable lithium battery may improve the lifetime characteristics and high-temperature storage properties. For example, the rechargeable lithium battery including the electrolyte as described in one or more embodiments of the present disclosure may maintain its capacity retention rate at high temperatures and may have suppression or reduction of resistance (e.g., electrical resistance) increase during high-temperature storage. Further, the electrolyte according to one or more embodiments of the present disclosure may have improved ion conductivity to exhibit enhanced rapid charge characteristics.

The additive may have an amount of about 0.01 to 10 wt %, about 0.1 to 5 wt %, about 0.1 to 3 wt %, or about 0.5 to 3 wt % relative to the total weight of the electrolyte.

If (e.g., when) the additive has an amount within the range above, the electrolyte may have suitable or appropriate viscosity, and may suitably satisfy wettability to negative and positive electrodes. In some embodiments, if (e.g., when) the additive has an amount within the range above, an effect as a surfactant may be exhibited.

### Rechargeable Lithium Battery

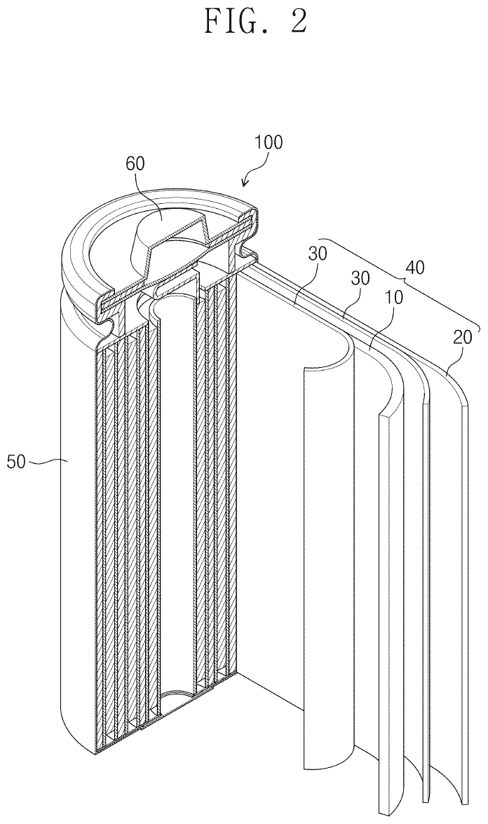

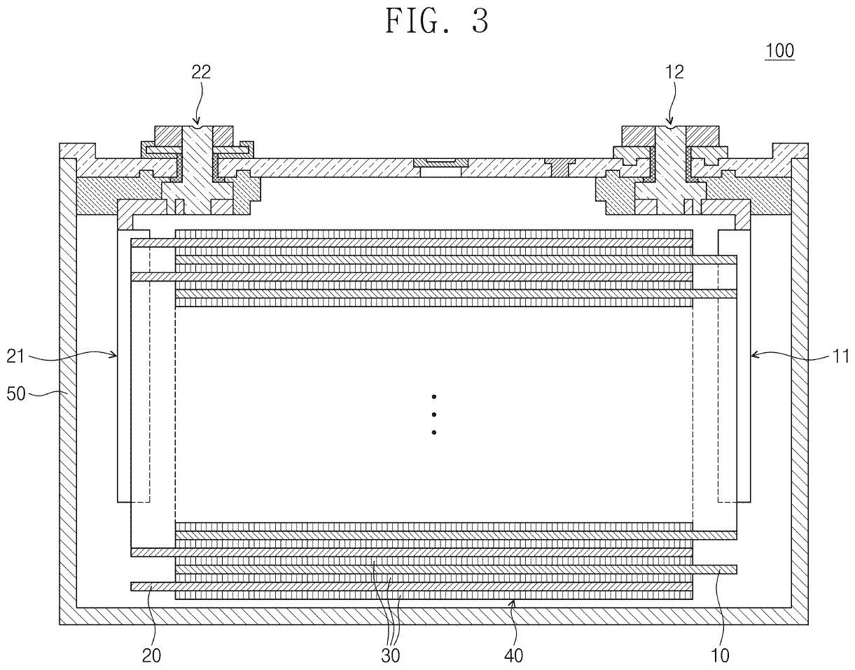

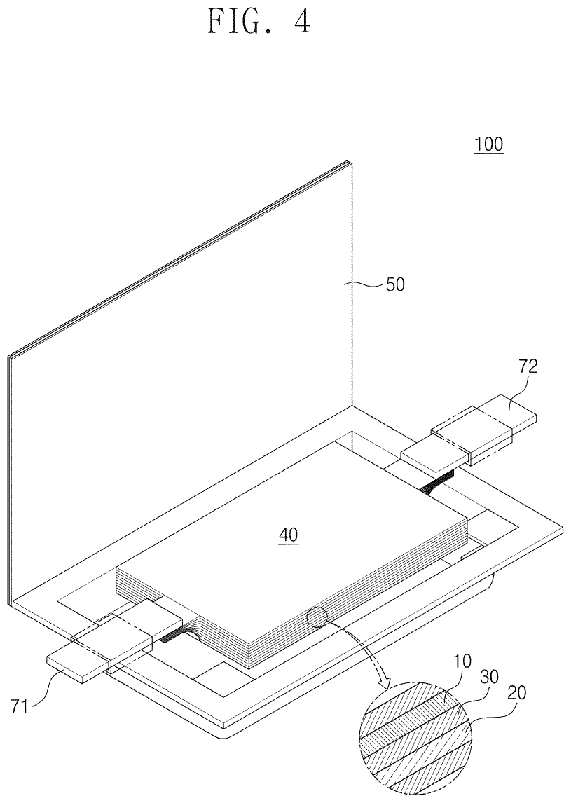

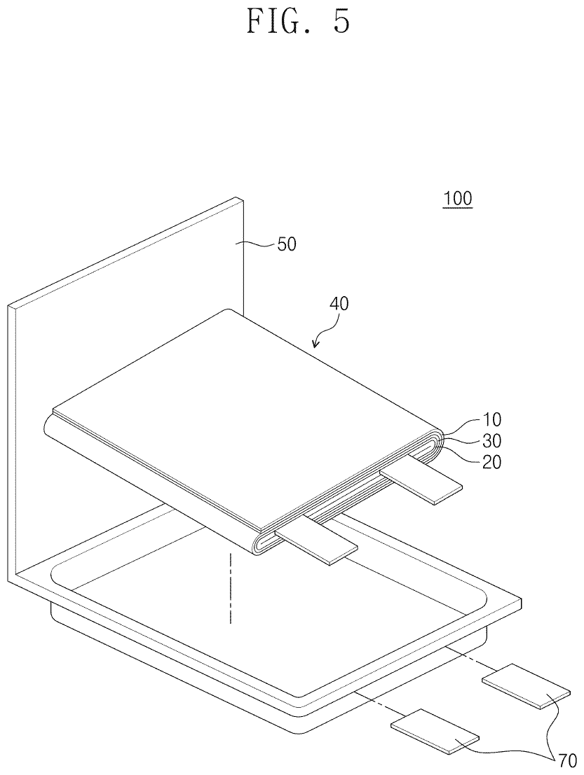

Based on the shape of a rechargeable lithium battery, the rechargeable lithium battery may be classified into cylindrical, prismatic, pouch, or coin types (or kinds). FIGS. 2-5 each is a simplified diagram showing a rechargeable lithium battery according to one or more embodiments of the present disclosure, FIG. 2 showing a cylindrical battery, FIG. 3 showing a prismatic battery, and FIGS. 4-5 each showing a pouch-type/kind battery. Referring to FIGS. 2-4, a rechargeable lithium battery 100 may include an electrode assembly 40 in which a separator 30 is between a positive electrode 10 and a negative electrode 20 and may also include a casing 50 in which the electrode assembly 40 is accommodated. The positive electrode 10, the negative electrode 20, and the separator 30 may be impregnated in an electrolyte. The rechargeable lithium battery 100 may include a sealing member 60 that seals the casing 50 as illustrated in FIG. 2. In some embodiments, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4-5, the rechargeable lithium battery 100 may include an electrode tab 70, or a positive electrode tab 71 and a negative electrode tab 72, which serve(s) as an electrical path for externally inducing a current generated in the electrode assembly 40.

The rechargeable lithium battery according to one or more embodiments of the present disclosure may be applied to automotive vehicles, mobile phones, and/or any other suitable electrical devices, but embodiments of the present disclosure are not limited thereto.

The following will describe a Synthesis Examples, Embodiments, and Comparative Examples of the present disclosure. The following Embodiments, however, are merely examples, and embodiments of the present disclosure are not limited to Embodiments described below.

### Synthesis Example 1

1 equivalent of 1,1′-thiobis[2-bromoethane], 3 equivalents of sodium azide, and dimethyl sulfoxide (DMSO) were added into a round-bottom flask and then agitated for 12 hours at room temperature. The resultant reaction mixture was extracted with dichloromethane and then concentrated. After the concentration, the mixture was dried using a vacuum pump, and then Chemical Formula 1-2-1 below was obtained.

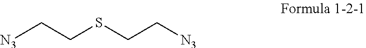 [SMILES: [N-]=[N+]=NCCSCCN=[N+]=[N-]]

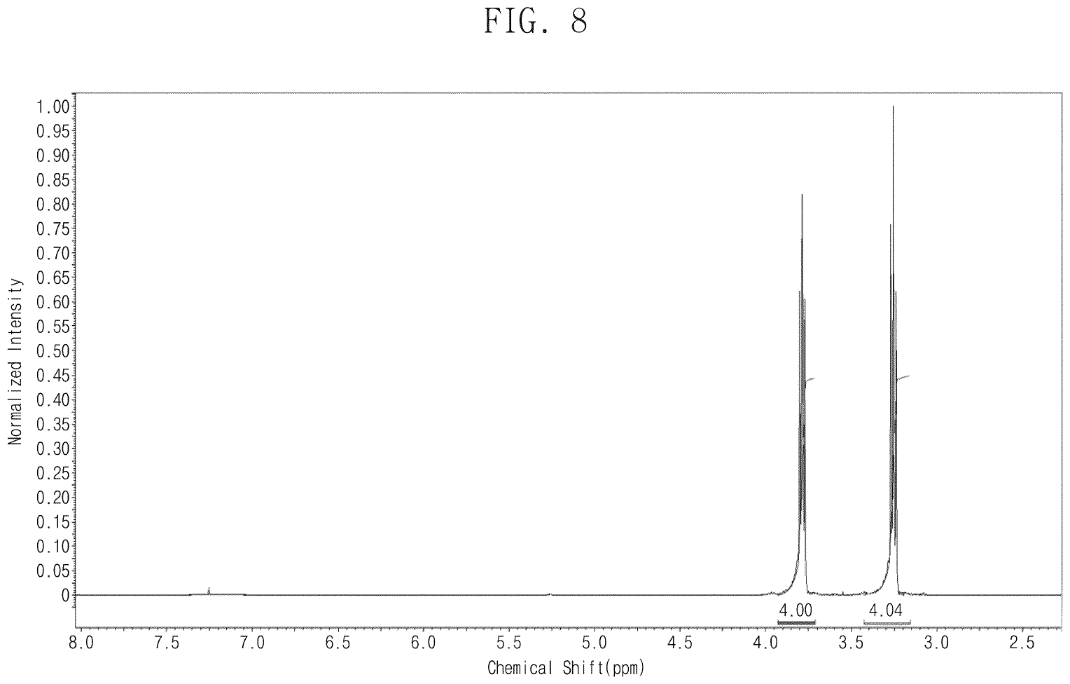

Afterwards, hydrogen peroxide 10 fold and acetic acid 20 fold with respect to the compound represented by Chemical Formula 1-2-1 as described in one or more embodiments of the present disclosure were added into a round-bottom flask and heated at 60° C. for 12 hours, and then the resultant mixture was cooled to room temperature. The reaction mixture was extracted with dichloromethane and concentrated, and then dried to obtain a compound represented by Chemical Formula 1-2 below. FIG. 8 is a ¹H NMR spectrum of the synthesized compound.

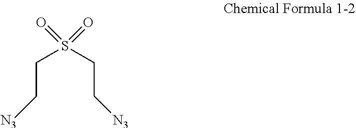 [SMILES: [N-]=[N+]=NCCS(=O)(=O)CCN=[N+]=[N-]]

(¹H NMR (400 MHz, CDCl₃, 25° C.) δ (ppm): 3.8 (4H), 3.25 (4H)) Embodiments and Comparative Examples

An electrolyte and a rechargeable lithium battery were fabricated by the following method.

### Embodiment 1

### (1) Preparation of Electrolyte

1.15 M LiPF₆ was dissolved in a non-aqueous organic solvent containing ethylene carbonate (EC), ethyl methyl carbonate (EMC), and dimethyl carbonate (DMC) mixed in a volume ratio of about 20:40:40, respectively, and 0.5 wt % of the additive represented by Chemical Formula 1-2 obtained in Synthesis Example 1 was added to prepare an electrolyte.

### (2) Fabrication of Rechargeable Lithium Battery

LiNi_{0.91}Co_{0.07}Al_{0.02}O₂ as a positive electrode active material, polyvinylidene fluoride as a binder, and carbon black as a conductive material were mixed in a weight ratio of 97:2:1, respectively, and the resultant mixture was dispersed in N-methyl pyrrolidone to prepare a positive electrode active material slurry.

The positive electrode active material slurry was coated on an aluminum (Al) current collector of 14 μm in thickness, dried at 110° C., and then pressed to manufacture a positive electrode.

Artificial graphite and silicon nanoparticles were mixed in a weight ratio of 93:7 as a negative electrode active material, a styrene butadiene rubber (SBR) as a binder, and carboxymethyl cellulose (CMC) as a thickener were mixed in a weight ratio of 97:1:2, respectively, and the resultant mixture was distributed in distilled water to prepare a negative electrode active material slurry.

The negative electrode active material slurry was coated on a copper (Cu) current collector of 10 μm in thickness, dried at 100° C., and then pressed to manufacture a negative electrode.

The positive electrode, the negative electrode, and a polyethylene separator of 25 μm in thickness were assembled to manufacture an electrode assembly, and the electrolyte was introduced to fabricate a rechargeable lithium battery.

### Embodiment 2

An electrolyte and a rechargeable lithium battery were fabricated in the same method as described in Embodiment 1, except that 1 wt % of the additive was added when the electrolyte was prepared.

### Embodiment 3

An electrolyte and a rechargeable lithium battery were fabricated in the same method as described in Embodiment 1, except that 3 wt % of the additive was added when the electrolyte was prepared.

### Comparative Example 1

An electrolyte and a rechargeable lithium battery were fabricated in the same method as described in Embodiment 1, except that no additive was added when the electrolyte was prepared.

### Comparative Example 2

An electrolyte and a rechargeable lithium battery were fabricated in the same method as described in Embodiment 1, except that 1 wt % of an additive represented by Chemical Formula 2 below was added when the electrolyte was prepared.

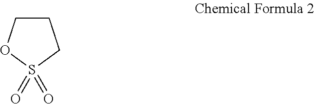

### Comparative Example 3

An electrolyte and a rechargeable lithium battery were fabricated in the same method as described in Embodiment 1, except that 1 wt % of an additive represented by Chemical Formula 3 below was added when the electrolyte was prepared.

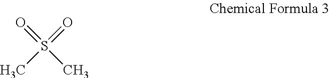

### Comparative Example 4

An electrolyte and a rechargeable lithium battery were fabricated in the same method as described in Embodiment 1, except that 1 wt % of an additive represented by Chemical Formula 4 below was added when the electrolyte was prepared.

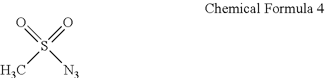

### Evaluation 1: Cyclic Voltammetry Characteristics—Reductive Decomposition

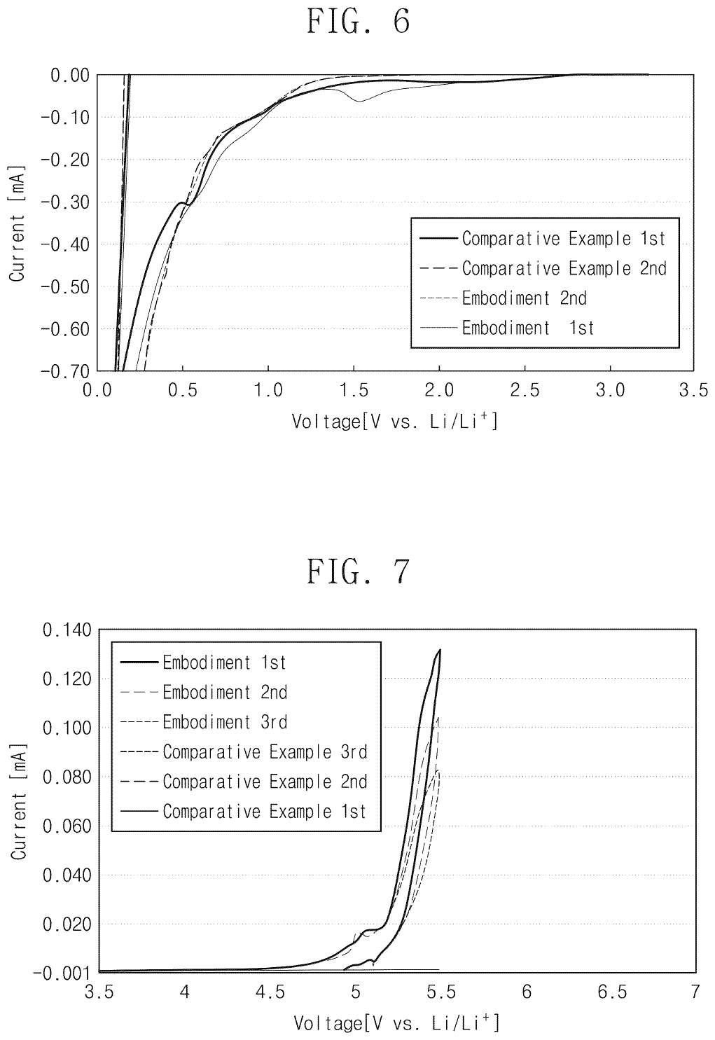

The electrolyte prepared according to Embodiment 1, a graphite working electrode, and a lithium (Li) counter electrode were used to measure a cyclic voltammetric voltage (scan rate: 0.1 mV/sec) of 3 electrodes, and the result is shown in FIG. 6.

The electrolyte prepared according to Comparative Example 1, a graphite working electrode, and a lithium (Li) counter electrode were used to measure a cyclic voltammetric voltage (scan rate: 1 mV/sec) of 3 electrodes, and the result is shown in FIG. 6.

In FIG. 6, the term, “Embodiment X,” indicates an X^{th} cycle. Referring to FIG. 6, the electrolyte prepared according to Embodiment 1 or an electrolyte including the additive prepared according to Synthesis Example 1 exhibited a decomposition peak, or a reduction peak, around 1.6 V. The electrolyte prepared according to Comparative Example 1 or an electrolyte including no additive exhibited a reduction peak around 0.6 V. This result is believed to mean that an additive is reductively decomposed earlier than a solvent to contribute to the formation of SEI.

### Evaluation 2: Cyclic Voltammetry Characteristics—Oxidative Decomposition

The electrolyte prepared according to Embodiment 1, a platinum (Pt) working electrode, and a lithium (Li) counter electrode were used to measure a cyclic voltammetric voltage (scan rate: 1.0 mV/sec) of 3 electrodes, and the result is shown in FIG. 7.

The electrolyte prepared according to Comparative Example 1, a platinum (Pt) working electrode, and a lithium (Li) counter electrode were used to measure a cyclic voltammetric voltage (scan rate: 1.0 mV/sec) of 3 electrodes, and the result is shown in FIG. 7.

In FIG. 7, the term, “Embodiment X,” indicates an X^{t}h cycle. Referring to FIG. 7, the electrolyte prepared according to Embodiment 1 or an electrolyte including the additive prepared according to Synthesis Example 1 underwent an oxidative decomposition from about 5 V. The electrolyte prepared according to Comparative Example 1 or an electrolyte including no additive did not exhibit an oxidation peak even up to 5.5 V. This result is believed to mean that an additive undergoes an oxidative decomposition from 5 V to contribute to the formation of CEI.

### Evaluation 3: Resistance Increase Rate During High-Temperature Storage

The rechargeable lithium batteries fabricated in Embodiments and Comparative Example were charged at room temperature (25° C.) to SOC 100% under the condition of constant current-constant voltage (CC/CV), 0.33 C, 4.25 V, and 0.025 C Cut-off, and then an initial battery resistance (DC-IR) and a battery resistance (DC-IR) after storage at 60 (C for 90 days were measured. A resistance increase rate was measured and the result is listed in Table 1 below. A resistance (DC-IR), which is calculated from a difference in current and voltage when different currents are applied, was obtained using Ohm's law ΔR=ΔV/ΔI after being discharged at 1 C for 30 seconds in an initial full charge state. The resistance increase rate was calculated according to Equation 1 below.

$$Resistance increase rate ( \% ) = [ battery resistance rate ( \% ) after 90 days / initial battery resistance ] \times 100 \qquad Equation 1$$

TABLE 1

| | | | | DC-IR | |
|---|---|---|---|---|---|
| | | Amount | | after high | |
| | Type/kind | of | Initial | temperature | DC-IR |
| | of | additive | DC-IR | storage | increase |
| | additive | (wt %) | (mΩ) | (mΩ) | rate (%) |
| Embodiment | Chemical | 0.5 | 9.05 | 10.84 | 119.8 |
| 1 | Formula 1-1 | | | | |
| Embodiment | Chemical | 1 | 9.11 | 10.95 | 120.2 |
| 2 | Formula 1-1 | | | | |
| Embodiment | Chemical | 3 | 9.17 | 11.05 | 120.5 |
| 3 | Formula 1-1 | | | | |
| Comparative | — | — | 9.02 | 12.01 | 133.1 |
| Example 1 | | | | | |
| Comparative | Chemical | 1 | 9.33 | 12.19 | 130.7 |
| Example 2 | Formula 2 | | | | |
| Comparative | Chemical | 1 | 9.29 | 12.31 | 132.5 |
| Example 3 | Formula 3 | | | | |
| Comparative | Chemical | 1 | 9.25 | 12.07 | 130.5 |
| Example 4 | Formula 4 | | | | |

Referring to Table 1, compared to the rechargeable lithium batteries according to Comparative Examples 1 to 4, the rechargeable lithium batteries according to Embodiments 1 to 3 have their reduced resistance increase rate during storage at a high temperature (60° C.).

### Evaluation 4: Lifetime Capacity Retention Rate at High Temperature

The rechargeable lithium batteries according to Embodiments and Comparative Examples were continuously charged and discharged at 45° C. for up to 300 cycles under the condition of 0.5 C charge and 0.5 C discharge, and then a capacity retention rate after 300 cycles is listed in Table 2 below.

The capacity retention rate was calculated according to Equation 2 below.

$$Capacity retention rate ( \% ) = ( discharge capacity at {300}^{th} cycle / initial discharge capacity ) \times 100 \qquad Equation 2$$

TABLE 2

| | | | Initial | Discharge | |
|---|---|---|---|---|---|
| | | Amount | dis- | capacity | |
| | Type/kind | of | charge | at 300^{th} | Capacity |
| | of | additive | capacity | cycle | retention |
| | additive | (wt %) | (mAh/g) | (mAh/g) | rate (%) |
| Embodiment | Chemical | 0.5 | 7.41 | 6.57 | 88.7 |
| 1 | Formula 1-1 | | | | |
| Embodiment | Chemical | 1 | 7.41 | 6.54 | 88.3 |
| 2 | Formula 1-1 | | | | |
| Embodiment | Chemical | 3 | 7.40 | 6.51 | 88.0 |
| 3 | Formula 1-1 | | | | |
| Comparative | — | — | 7.41 | 6.27 | 84.6 |
| Example 1 | | | | | |
| Comparative | Chemical | 1 | 7.42 | 6.22 | 83.8 |
| Example 2 | Formula 2 | | | | |
| Comparative | Chemical | 1 | 7.41 | 6.02 | 81.2 |
| Example 3 | Formula 3 | | | | |
| Comparative | Chemical | 1 | 7.43 | 6.31 | 84.9 |
| Example 4 | Formula 4 | | | | |

Referring to Table 2, compared to the rechargeable lithium batteries according to Comparative Examples 1 to 4, the rechargeable lithium batteries according to Embodiments 1 to 3 have their increased capacity retention rate at a high temperature (45° C.).

A rechargeable lithium battery according to one or more embodiments of the present disclosure may have an improvement in the lifetime characteristics and suppression or reduction in battery resistance (e.g., electrical resistance) increase during high-temperature storage.

While the subject matter of this disclosure has been described in connection with what is presently considered to be example embodiments, it is to be understood that the present disclosure is not limited to the disclosed embodiments and is intended to cover various suitable modifications and equivalent arrangements included within the spirit and scope of the appended claims and equivalents thereof, and therefore the aforementioned embodiments should be understood to be examples but not limiting this disclosure in any way.

What is claimed is:

1. An electrolyte, comprising:
a non-aqueous organic solvent;
a lithium salt; and
an additive represented by Chemical Formula 1, 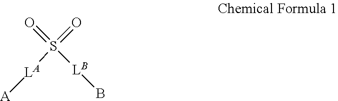
wherein, in Chemical Formula 1,
L^{A} and L^{B} are each independently a substituted or unsubstituted C1 to C5 alkylene group, a substituted or unsubstituted C2 to C5 alkenylene group, a substituted or unsubstituted C2 to C5 alkynylene group, or a substituted or unsubstituted C6 to C20 arylene group,
A and B are each independently a substituted or unsubstituted C1 to C20 alkyl group, a substituted or unsubstituted C6 to C20 aryl group, or a substituted or unsubstituted C2 to C20 heteroaryl group, and
at least one selected from A and B is an azide group, and
wherein the electrolyte is an electrolyte for a rechargeable lithium battery.

2. The electrolyte as claimed in claim 1, wherein at least one selected from L^{A} and L^{B} is a substituted or unsubstituted C1 to C5 alkylene group.

3. The electrolyte as claimed in claim 1, wherein L^{A} and L^{B} are each independently a substituted or unsubstituted C1 to C5 alkylene group.

4. The electrolyte as claimed in claim 1, wherein at least one selected from L^{A} and L^{B} is a substituted or unsubstituted C2 to C4 alkylene group.

5. The electrolyte as claimed in claim 1, wherein L^{A} and L^{B} are each independently a substituted or unsubstituted C2 to C4 alkylene group.

6. The electrolyte as claimed in claim 1, wherein Chemical Formula 1 is represented by Chemical Formula 1-1, 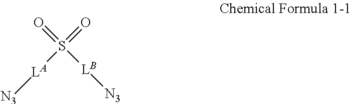
wherein, in Chemical Formula 1-1, L^{A} and L^{B} are each independently substituted or unsubstituted C2 to C4 alkylene.

7. The electrolyte as claimed in claim 1, wherein the additive is represented by Chemical Formula 1-2 or Chemical Formula 1-3,

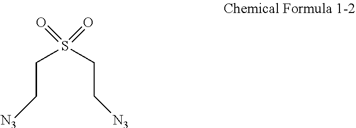 [SMILES: [N-]=[N+]=NCCS(=O)(=O)CCN=[N+]=[N-]]

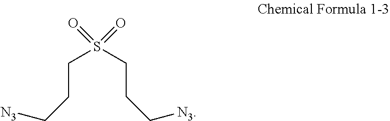 [SMILES: [N-]=[N+]=NCCCS(=O)(=O)CCCN=[N+]=[N-]]

8. The electrolyte as claimed in claim 1, wherein the additive is present in an amount of about 0.01 part by weight to about 10.0 parts of weight relative to 100 parts by weight of the electrolyte for the rechargeable lithium battery.

9. The electrolyte as claimed in claim 1, wherein the non-aqueous organic solvent comprises a carbonate-based solvent.

10. The electrolyte as claimed in claim 9, wherein the carbonate-based solvent comprises ethyl methyl carbonate (EMC), ethylene carbonate (EC), and dimethyl carbonate (DMC).

11. The electrolyte as claimed in claim 1, wherein the lithium salt comprises LiPF₆.

12. The electrolyte as claimed in claim 1, wherein a concentration of the lithium salt is in a range of about 0.1 M to about 2.0 M.

13. A compound represented by Chemical Formula 1-2,

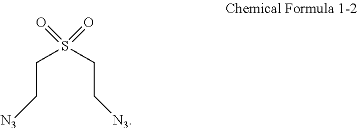 [SMILES: [N-]=[N+]=NCCS(=O)(=O)CCN=[N+]=[N-]]

14. A rechargeable lithium battery, comprising:
a positive electrode, wherein the positive electrode comprises a positive electrode active material;
a negative electrode, wherein the negative electrode comprises a negative electrode active material; and
the electrolyte for the rechargeable lithium battery as claimed in claim 1.

15. The rechargeable lithium battery as claimed in claim 14, wherein the positive electrode active material comprises a compound represented by Chemical Formula 2, 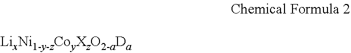
wherein, in Chemical Formula 2,
0.9≤x≤1.8, 0≤y≤0.5, 0≤z≤0.5, and 0<a<2,
X comprises at least one selected from among aluminum (Al), nickel (Ni), cobalt (Co), manganese (Mn), chromium (Cr), iron (Fe), magnesium (Mg), strontium (Sr), vanadium (V), a rare-earth element, and a combination thereof, and
D comprises at least one selected from among oxygen (O), fluorine (F), sulfur (S), phosphorus (P), and a combination thereof.

16. The rechargeable lithium battery as claimed in claim 14, wherein the negative electrode active material comprises a carbon-based negative electrode active material or a Si-based negative electrode active material.
